(19) United States
(12) Patent Application Publication
(10) Pub. No.: US 2013/0147595 A1
(43) Pub. Date: Jun. 13, 2013

(54) COIL PARTS

(71) Applicant: C/O SAMSUNG ELECTRO-MECHANICS CO., LTD, Gyeonggi-do (KR)

(72) Inventors: Sang Moon Lee, Seoul (KR); Sung Kwon Wi, Seoul (KR); Jeong Bok Kwak, Gyeonggi-do (KR); Won Chul Sim, Gyeonggi-do (KR); Young Seuck Yoo, Seoul (KR); Yong Suk Kim, Gyeonggi-do (KR)

(73) Assignee: C/O SAMSUNG ELECTRO-MECHANICS CO., LTD., Gyeonggi-do (KR)

(21) Appl. No.: 13/712,632

(22) Filed: Dec. 12, 2012

(30) Foreign Application Priority Data
Dec. 12, 2011 (KR) 10-2011-0132888

(51) Int. Cl. H01F 19/04

(52) U.S. Cl. CPC H01F 19/04
USPC 336/220

(57) ABSTRACT

Disclosed herein are coil parts including: a lower magnetic substance; a primary coil pattern disposed on the lower magnetic substance; a first complex layer for covering the primary coil pattern; a secondary coil pattern correspondingly disposed on an upper side of the primary coil pattern; a second complex layer for covering the secondary coil pattern; and an insulation layer disposed between the primary coil pattern and the secondary coil pattern and blocking an electrical connection between the primary coil pattern and the secondary coil pattern. The coil parts according to the present invention can have a simple structure and processing capable of increasing magnetic permeability and accordingly improving an impedance characteristic of the coil parts, thereby implementing excellent performance and characteristic.

### CROSS REFERENCE(S) TO RELATED APPLICATIONS

This application claims the benefit under 35 U.S.C. Section 119 of Korean Patent Application Serial No. 10-2011-0132888, entitled “Coil Parts” filed on Dec. 12, 2011, which is hereby incorporated by reference in its entirety into this application.

### BACKGROUND OF THE INVENTION

1. Technical Field

The present invention relates to coil parts for a noise removal, and more particularly, to coil parts having simple structure and processing capable of increasing magnetic permeability and improving an impedance characteristic, thereby enhancing performance.

2. Description of the Related Art

Electronic products such as a digital TV, a smartphone, a notebook, etc. have been widely used to perform functions of transmitting and receiving data in a high frequency band. In the near future, such IT electronic products are connected to each other through USBs and other communication ports thereof as well as single devices, and thus are expected to have the high frequency of use as multifunctional and complex products.

In this regard, to quickly transmit and receive data, electronic products move from a MHz frequency band to a GHz high frequency band and transmit and receive a large amount of data through internal signal lines.

There is a problem in smoothly processing data due to a signal delay and other noise when data is transmitted and received in the GHz high frequency band between a main device and a peripheral device in order to transmit and receive such large amount of data.

To solve this problem, although EMI measure parts are equipped with the connection of IT electronic products and peripheral devices, since given EMI measure parts are winding types and stacking types having large chip sizes and bad electrical characteristics, the EMI measure parts can be used in a limited region such as a specific part and a large area circuit board. Accordingly, EMI measure parts are required to satisfy the conversion of electronic products into slim, small-sized, complex, and multifunctional products.

A common mode filter among EMI measure coil parts according to the prior art will now be described in more detail with reference to FIGS. 1 through 2C.

Referring to FIGS. 1 through 2C, a conventional common mode filter includes a lower magnetic substrate 10, an insulation layer 20 disposed on an upper portion of the lower magnetic substrate 10 and including a first coil pattern 21 and a second coil pattern 22 symmetrically formed up and down, and an upper magnetic substance 30 disposed on an upper portion of the insulation layer 20.

In this regard, the insulation layer 20 is formed on the upper portion of the lower magnetic substrate 10 and including the first coil pattern 21 and the second coil pattern 22 through a thin film process. An example of the thin film process is disposed in Japanese Patent Laid-Open Publication No. 8-203737.

A first input read pattern 21a and a first output read pattern 21b for inputting and outputting electricity to and from the first coil pattern 21 and a second input read pattern 22a and a second output read pattern 22b for inputting and outputting electricity to and from the second coil pattern 22 are formed in the insulation layer 20.

More specifically, the insulation layer 20 includes a first coil layer including the first coil pattern 21 and the first input read pattern 21a, a second coil layer including the second coil pattern 22 and the second input read pattern 22a, and a third coil layer including the first output read pattern 21b and the second output read pattern 22b.

That is, the first coil layer is formed by forming the first coil pattern 21 and the first input read pattern 21a on an upper surface of the lower magnetic substrate 10 through the thin film process and then coating an insulation material on the first coil pattern 21 and the first input read pattern 21a.

Then, the second coil layer is formed by forming the second coil pattern 22 corresponding to the first coil pattern 21 and the second input read pattern 22a on an upper surface of the first coil layer through the thin film process and then coating an insulation material on the second coil pattern 22 and the second input read pattern 22a.

Then, the third coil layer is formed by forming the first output read pattern 21b and the second output read pattern 22b on an upper surface of the second coil layer through the thin film process for external outputs of the first coil pattern 21 and the second coil pattern 22 and then coating an insulation material on the first output read pattern 21b and the second output read pattern 22b.

In this regard, the first coil pattern 21 and the second coil pattern 22 may be electrically connected to the first output read pattern 21b and the second output read pattern 22b, respectively, by a via connection structure.

Meanwhile, the first input read pattern 21a is connected to a first external input terminal 41a, the first output read pattern 21b is connected to a first external output terminal (not shown) corresponding to the first external input terminal 41a, the second input read pattern 22a is connected to a second external input terminal 42a, and the second output read pattern 22b is connected to a second external output terminal (not shown) corresponding to the second external input terminal 42a.

Although not shown in detail, the first through third coil layers are manufactured in sheet forms and combined with each other in stacking manner and thus may include an insulation layer including the above-described first and second coil patterns, first and second input read patterns, and first and second output read patterns.

Meanwhile, the upper magnetic substance 30 is formed by filling a complex material in which ferrite and resin as a binder are mixed in order to enhance bonding and insulation properties between the upper magnetic substance 30 and the insulation layer 20. In this case, magnetic permeability of the common mode filter is remarkably reduced due to the resin included in the upper magnetic substance 30, which problematically deteriorates performance and characteristic of the common mode filter.

In this connection, if a particle diameter of the ferrite included in the upper magnetic substance 30 increases in order to increase the magnetic permeability of the common mode filter, a high frequency characteristic of the common mode filter problematically deteriorates. If an amount of the resin as the binder of the upper magnetic substance 30 is reduced, bonding and insulation properties and a withstand voltage characteristic of the upper magnetic substance 30 problematically deteriorate.

Furthermore, there is a method of providing a high temperature environment when the upper magnetic substance 30 is formed in order to increase the magnetic permeability of the common mode filter. However, operatibility deteriorates in the high temperature environment or equipment for increasing a temperature increases and reliability of the common mode filter deteriorates.

### SUMMARY OF THE INVENTION

An object of the present invention is to provide coil parts having a simple structure and processing capable of increasing magnetic permeability and improving an impedance characteristic, thereby enhancing performance.

Another object of the present invention is to provide coil parts capable of accurately blocking an electrical connection between coil patterns while implementing high magnetic permeability.

According to an exemplary embodiment of the present invention, there is provided coil parts including: a lower magnetic substance; a primary coil pattern disposed on the lower magnetic substance; a first complex layer for covering the primary coil pattern; a secondary coil pattern correspondingly disposed on an upper side of the primary coil pattern; a second complex layer for covering the secondary coil pattern; and an insulation layer disposed between the primary coil pattern and the secondary coil pattern and blocking an electrical connection between the primary coil pattern and the secondary coil pattern.

The coil parts may further include: a third complex layer disposed on an upper side of the secondary coil pattern, and for covering a first output read pattern and a second output read pattern for electricity outputs of the primary coil pattern and the secondary coil pattern.

The first, second, and third complex layers may include resin, photo resist, and ferrite powder.

The resin and the photo resist may have a mixing ratio of 2:1 as a weight ratio. A particle diameter of the ferrite powder may be substantially 3 μm.

The first, second, and third complex layers may further include a dispersing agent.

The primary coil pattern and the first output read pattern may be connected to each other through a via, and a via hole corresponding to the via may be formed in the insulation layer.

The insulation layer may be formed of an electricity insulating material.

### BRIEF DESCRIPTION OF THE DRAWINGS

FIG. 1 is a schematic cross-sectional view of a common mode filter among conventional coil parts;

FIG. 2A is a schematic plan view of a first coil pattern of FIG. 1;

FIG. 2B is a schematic plan view of a second coil pattern of FIG. 1;

FIG. 2C is a schematic plan view of an output read pattern of the first coil pattern of FIG. 2A and an output read pattern of the second coil pattern of FIG. 2B;

FIG. 3 is a schematic cross-sectional view of coil parts according to an exemplary embodiment of the present invention; and

FIG. 4 is a schematic flowchart of a method of manufacturing coil parts according to an exemplary embodiment of the present invention.

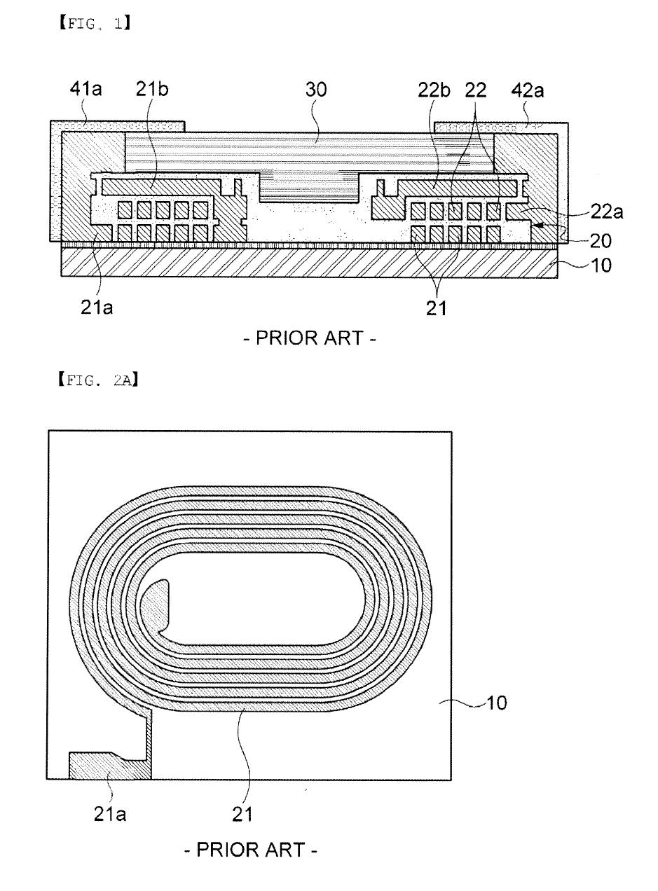

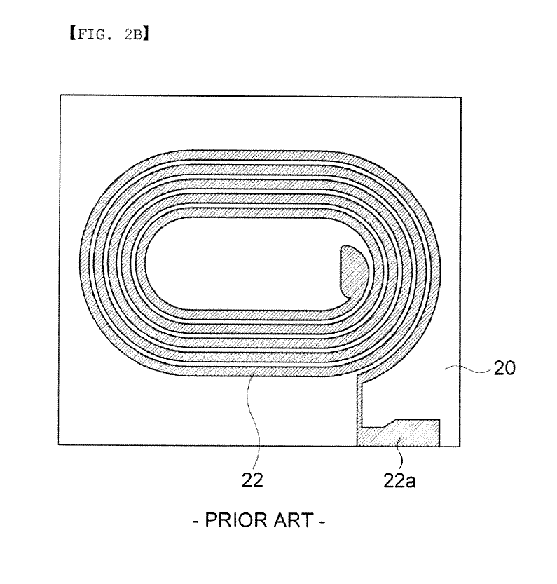

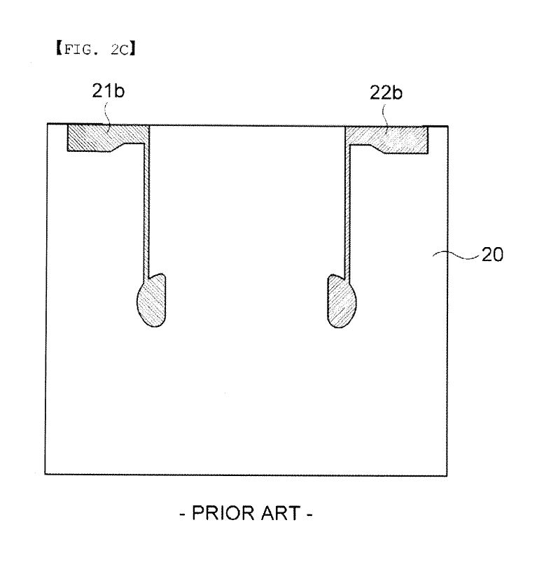

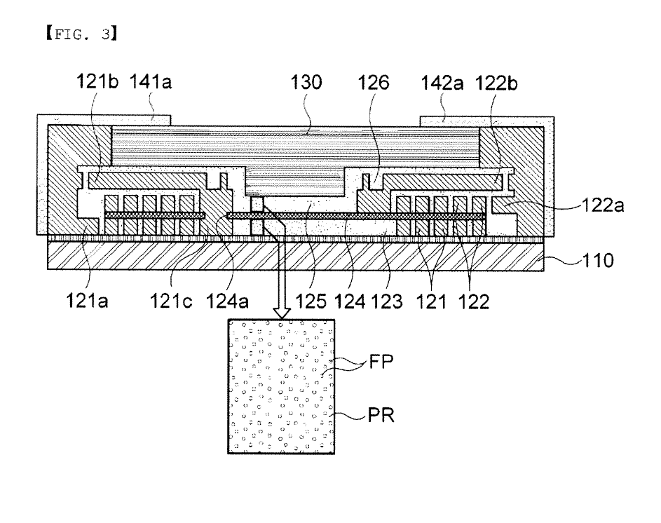

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes. For example, an etching region vertically shown may be rounded or may have a predetermined curvature. Therefore, the illustrated regions in the drawings have schematic attributes, and the shapes of the illustrated regions in the drawings are for illustrating specific shapes and are not for limiting the scope of the present invention.

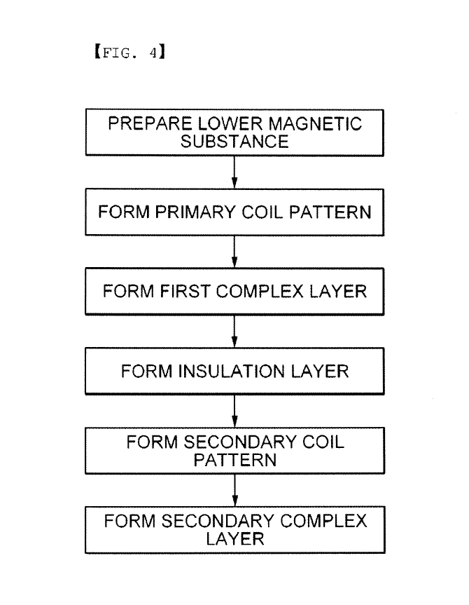

Hereinafter, an embodiment of a coil pattern and coil parts including the coil pattern according to the present invention will be described in more detail with reference to FIGS. 3 through 4 of the accompanying drawings.

FIG. 3 is a schematic cross-sectional view of coil parts according to an exemplary embodiment of the present invention. FIG. 4 is a schematic flowchart of a method of manufacturing coil parts according to an exemplary embodiment of the present invention.

Referring to FIG. 3, the coil parts according to an exemplary embodiment of the present invention may include a lower magnetic substance 110, a coil layer disposed on an upper portion of the lower magnetic substance 110 and including a primary coil pattern 121 and a secondary coil pattern 122 symmetrically formed up and down, and an upper magnetic substance 130 disposed on an upper portion of the coil layer.

The lower magnetic substance 110 may be configured in a substrate form including a ferrite based magnetic substance.

The coil layer may include the primary coil pattern 121 disposed on the lower magnetic substance 110, a first complex layer 123 covering the primary coil pattern 121, a secondary coil pattern 122 correspondingly disposed on an upper side of the primary coil pattern 121, a second complex layer 125 covering the secondary coil pattern 122, and an insulation layer 124 disposed between the primary coil pattern 121 and the secondary coil pattern 122 and blocking an electrical connection between the primary coil pattern 121 and the secondary coil pattern 122.

In this regard, the primary coil pattern 121 and the second coil pattern 122 may be formed through a thin film process, and the first complex layer 123 and the second complex layer 125 may be formed of the same material and integrally formed after the coil layer is formed.

The first complex layer 123 and the second complex layer 125 may be formed of a complex material including resin, photo resist (PR), and ferrite powder (FP), and accordingly, a ferrite component is added to the first complex layer 123 and the second complex layer 125, and thus magnetic permeability of the coil parts including the ferrite component increases, thereby enhancing product performance owing to an improvement of an impedance characteristic.

In this regard, the resin and the PR may have a mixing ratio of 2:1 as a weight ratio. That is, the first complex layer 123 and the second complex layer 125 may include the resin and the PR, and the FP, respectively. In this regard, an amount of the resin mixed to the PR may be two times the weight ratio of the PR.

A particle diameter of the FP may be substantially 3 μm. In a case where the particle diameter of the FP is less than 3 μm, an effect of enhancing the magnetic permeability is insignificant, and in a case where the particle diameter of the FP exceeds 3 μm, the magnetic permeability is enhanced whereas an amount of the resin and the PR is relatively reduced, and thus a new problem in that insulation properties of the primary coil pattern 121 and the secondary coil pattern 122 may deteriorate.

In addition, in order to secure insulation properties between the primary coil pattern 121 and the secondary coil pattern 122 in the present embodiment, the insulation layer 124 is disposed between the primary coil pattern 121 and the secondary coil pattern 122.

In this regard, the insulation layer 124 may be formed of an electricity insulating material. For example, the insulation layer 124 may be formed of a PSV that is a kind of photosensitive resin, and accordingly, the insulation layer 124 has excellent surface planarization, which enables to form a uniform pattern by preventing the secondary coil pattern 122 from breaking.

Meanwhile, the coil layer of the present embodiment may further include a third complex layer 126 disposed on an upper side of the second complex layer 125 and covering the first output read pattern 121b and the second output read pattern 122b for electricity outputs of the primary coil pattern 121 and the secondary coil pattern 122.

The third complex layer 126 may be also formed of a complex material including resin, the PR, and the FP. In this regard, the resin and the PR may have a mixing ratio of 2:1 as a weight ratio, and the particle diameter of the FP may be substantially 3 μm.

The third complex layer 126 may be integrally formed with the first complex layer 123 and the second complex layer 125 after the coil layer is formed.

Meanwhile, all of the first through third complex layers 123, 125, and 126 may further include a dispersing agent.

That is, the first through third complex layers 123, 125, and 126 include the FP, thereby uniformly enhancing the magnetic permeability by uniformly dispersing the FP, and accordingly all of the first through third complex layers 123, 125, and 126 may be configured to include the dispersing agent.

Meanwhile, the primary coil pattern 121 and the first output read pattern 121b may be electrically connected to each other through a via 121c for the electricity output of the primary coil pattern 121 in the present embodiment.

To this end, a via hole 124a for forming the via 121c may be formed in the insulation layer 124.

Meanwhile, the first input read pattern 121a for the electricity input of the primary coil pattern 121 may be formed in the primary complex layer 123, and the second input read pattern 122a for the electricity input of the secondary coil pattern 122 may be formed in the second complex layer 125.

The first input read pattern 121a may be connected to the first external input terminal 141a. The first output read pattern 121b may be connected to a first external output terminal (not shown) corresponding to the first external input terminal 141a. The second input read pattern 122a may be connected to the second external input terminal 142a. The second output read pattern 122b may be connected to a second external output terminal (not shown) corresponding to the second external input terminal 142a.

Next, a process of manufacturing the above-configured coil parts of the present embodiment will now be described in more detail.

Referring to FIGS. 3 and 4, the lower magnetic substance 110 is prepared, and then the primary coil pattern 121 is formed on the lower magnetic substance 110 through a thin film process.

Thereafter, the first complex layer 123 covering the primary coil pattern 121 is formed, and then the insulation layer 124 is formed on the first complex layer 123.

The secondary coil pattern 122 is formed on the insulation layer 124, and then the second complex layer 125 covering the secondary coil pattern 122 is formed.

Thereafter, the via 121c that passes through the first output read pattern 121b, the second output read pattern 122b, the second complex layer 125, and the insulation layer 124 is formed on the second complex layer 125.

In this regard, the primary coil pattern 121 and the first output read pattern 121b may be electrically connected to each other through the via 121c.

Thereafter, the third complex layer 126 covering the first output read pattern 121b, the second output read pattern 122b, and the via 121c is formed, and thus the coil layer may be manufactured.

Then, after the upper magnetic substance 130 is formed on the coil layer, the first and second external input terminals 141a and 142a and the first and second external output terminals (not shown) are formed, and thus the coil parts according to the present embodiment may be completely manufactured.

As described above, the coil parts according to the present invention have a simple structure and processing capable of increasing magnetic permeability and accordingly improving an impedance characteristic of the coil parts, thereby enhancing performance and reliability of a product.

Further, the coil parts according to the present invention can accurately block an electrical connection between a first coil pattern and a second coil pattern in addition to increasing magnetic permeability of the coil parts.

The present invention has been described in connection with what is presently considered to be practical exemplary embodiments. Although the exemplary embodiments of the present invention have been described, the present invention may also be used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. Coil parts comprising:
a lower magnetic substance;
a primary coil pattern disposed on the lower magnetic substance;
a first complex layer covering the primary coil pattern;
a secondary coil pattern correspondingly disposed on an upper side of the primary coil pattern;
a second complex layer covering the secondary coil pattern; and
an insulation layer disposed between the primary coil pattern and the secondary coil pattern and blocking an electrical connection between the primary coil pattern and the secondary coil pattern.

2. The coil parts according to claim 1, further comprising: a third complex layer disposed on an upper side of the secondary coil pattern, and covering a first output read pattern and a second output read pattern for electricity outputs of the primary coil pattern and the secondary coil pattern.

3. The coil parts according to claim 2, wherein the first, second, and third complex layers include resin, photo resist, and ferrite powder.

4. The coil parts according to claim 3, wherein the resin and the photo resist have a mixing ratio of 2:1 as a weight ratio.

5. The coil parts according to claim 3, wherein a particle diameter of the ferrite powder is substantially 3 μm.

6. The coil parts according to claim 3, wherein the first, second, and third complex layers further include a dispersing agent.

7. The coil parts according to claim 2, wherein the primary coil pattern and the first output read pattern are connected to each other through a via, and a via hole corresponding to the via is formed in the insulation layer.

8. The coil parts according to claim 1, wherein the insulation layer is formed of an electricity insulating material.
